(19) United States
(12) Patent Application Publication
(10) Pub. No.: US 2012/0031842 A1
(43) Pub. Date: Feb. 9, 2012

(54) METHOD FOR MODIFYING COMPOSITE MEMBRANES FOR LIQUID SEPARATIONS

(75) Inventors: Viatcheslav Freger, Beer Sheva (IL); Sophia Belfer, Beer Sheva (IL); Roy Berenstein, Meytar (IL)

(73) Assignee: BEN-GURION UNIVERSITY OF THE NEGEV RESEARCH AND DEVELOPMENT AUTHORITY, BEER-SHEVA, IL (US)

(21) Appl. No.: 13/138,250

(22) PCT Filed: Jan. 28, 2010
(86) PCT No.: PCT/IL2010/000071

§ 371 Date: Oct. 31, 2011

Related U.S. Application Data
(60) Provisional application No. 61/202,122, filed on Jan. 29, 2009.

(51) Int. Cl. C02F 1/44; C08J 5/22

(52) U.S. Cl. 210/650; 521/27; 210/500.21

(57) ABSTRACT

A method for modifying the surface of nanofiltration (NF) and reverse osmosis (RO) composite membranes, comprising placing said composite membrane in a suitable vessel having a feed inlet opening and a permeate outlet opening, feeding an aqueous solution of one or more monomer(s) and free radical initiator into said vessel through said inlet opening, generating transmembrane pressure, thereby creating a flux across said membrane into said permeate outlet opening and causing said monomer(s) graft polymerize in the presence of said free radical initiator onto one face of said composite membrane.

Pressure driven membranes processes are classified according to the following categories: microfiltration, ultrafiltration (UF), nanofiltration (NF) and reverse osmosis (RO). The membranes used for microfiltration and ultrafiltration are characterized by a well-defined, essentially permanent porous structure, with pore size ranging between 0.1 and 10 μm and 1 and 100 nm, respectively. The pores in nanofiltration and reverse osmosis membranes are significantly smaller (in the order of angstroms) and reverse osmosis membranes are often not even considered to have pores; the passage of liquid through nanofiltration and reverse osmosis membranes is accomplished through the spaces between the polymer molecules forming the dense polymer film of which the membrane is composed.

The composite membrane for NF and RO generally comprises two or three distinct layers, placed on top of each other. The thin, dense, non-porous active top layer is 10 to 1000 nm thick, providing the separation selectivity. The aforementioned thin layer is placed on top of a thicker asymmetrically porous layer (10 to 1000 micron thick), providing the mechanical strength and having low hydraulic resistance to permeate flow. In most commercial membranes a second supporting layer is further reinforced with bottom layer made of a non-woven polymer fabric. The top layer is usually produced using interfacial polymerization and is composed of polyamide or polyurea polymer, sometimes with an additional layer of polyvinyl alcohol or other polymers. Other important methods for preparing the composite membranes include coating and plasma polymerization. The porous layer is produced from polysulfone, polyethersulfone, polyacrylonitrile and other polymers using the method of phase inversion (solution precipitation). Another type of composite RO and NF membranes, which differs from the multilayer composites described above, is integrally-skinned membrane, in which both the dense top and porous supporting layers are formed from one polymer (e.g., cellulose acetate) in one manufacturing step by phase inversion. The structures of the composite and integrally-skinned NF and RO membranes set forth above and methods for manufacturing the same are described, for example, in M. Mulder, Basic Principles of Membrane Technology; Kluwer Academic Publishers: Dordrecht, The Netherlands, 1991.

In addition to the essential composite structure, surface modification is often used to vary the surface characteristics of composite membranes, e.g., in order to reduce propensity to fouling, with minimal impact on their other advantageous characteristics, such as flux and rejection of salts. The techniques for surface modification include coating the composite membrane with another layer, adsorption, chemical transformation of the active layer and surface graft-polymerization. The latter method is usually carried out by means of radical polymerization, by exposing the composite membrane to a solution of various unsaturated monomers (e.g., styrene derivatives, acrylates etc.). Such reactions, however, must be activated thermally, photochemically (e.g., by UV-irradiation and photoinitiators) or chemically using appropriate chemical initiators, in order to generate free radicals necessary for starting out the polymerization reaction. The use of chemical, initiators is often complicated by undesired homopolymerization, whereby most of the monomer is polymerized in bulk solution rather than on the surface of the composite membrane.

U.S. Pat. No. 6,280,853 describes a method for modifying the surface of a composite membrane comprising a porous support and a crosslinked polyamide discriminating layer, by chemically grafting polyalkylene oxide groups to the surface of the discriminating layer without using chemical initiators.

WO 2006/030411 describes the modification of the surface of commercially available composite polyamide NF and RO membranes, by a free-radical graft polymerization on the surface of said membranes, using a redox initiator.

The present invention relates to the modification of the surface of composite membranes. As was briefly mentioned above, the term “composite membranes” refers to membranes composed of chemically and structurally distinct layers, which membranes are useful in nanofiltration or reverse osmosis processes. The composite membrane to be treated and modified according to the present invention preferably contains at least a first layer, which is a porous support (e.g., polysulfone support) and a second, dense layer having no permanent pores, which is a polymeric thin film (e.g., polyamide) deposited on said support in order to allow the rejection of various solutes; hereinafter, this second layer is sometimes referred to as the active layer.

The inventors have found that it is possible to effectively apply an extra thin layer of a chemically distinct polymer predominantly onto the active layer of a composite membrane by means of graft polymerization. More specifically, the inventors have found that monomers in a solution can be driven to preferentially graft-polymerize onto the surface of a composite membrane which is in contact with said solution upon generating a pressure difference across the membrane (transmembrane pressure, which is the difference in pressure between the two sides of the membrane). Due to this pressure difference, the solvent (water) is caused to flow across the membrane whereas the monomer(s) and initiators which are dissolved in the solution are effectively stopped by the membrane and are caused to concentrate on the membrane surface (the phenomenon of concentration polarization). As a result, the competitive, undesired homopolymerization of the monomers in the bulk solution is essentially prevented. Thus, smaller amounts of the monomer(s) and initiator(s) are required in order to reach a satisfactory degree of grafting onto the membrane surface, as compared to the amounts of reagents applied when the solution is not subjected to pressure. As illustrated in the examples below, the modified composite membrane thus obtained exhibits rejection of various chemical species to a very good extent.

Accordingly, the present invention provides a method, which comprises placing a composite membrane in a suitable vessel, introducing a solution of one or more monomer(s) into said vessel, and causing said monomer(s) to graft polymerize in the presence of at least one initiator onto one face of said composite membrane upon generating transmembrane pressure. The solution is caused to flow on one face of the membrane (on the active layer). While the solvent (i.e., water) flows across the membrane and forms a permeate, the solutes, namely, the monomer(s) and initiator(s), are rejected by the membrane and concentrate in the vicinity on the membrane's surface, at the upstream side of the membrane, accomplishing the desired graft polymerization at a rate significantly larger than that in the bulk (homopolymerization).

The present invention is therefore primarily directed to a method for modifying the surface of nanofiltration (NF) and reverse osmosis (RO) composite membranes, comprising placing said composite membrane in a suitable vessel having a feed inlet opening and a permeate outlet opening, feeding an aqueous solution of one or more monomer(s) and free radical initiator into said vessel through said inlet opening, generating transmembrane pressure, thereby creating a flux across said membrane into said permeate outlet opening and causing said monomer(s) to graft polymerize in the presence of said free radical initiator onto one face of said composite membrane

The composite membranes to be modified according to the invention are two- or three-layer composite or integrally-skinned RO and NF membranes as set forth above. The structures of such membranes, useful as starting material according to the invention, and methods for their manufacture are described for example, in M. Mulder [supra]. Methods of fabricating composite membrane by coating a porous support with an aqueous solution of a polyfunctional amine monomer, and the subsequent formation of a crosslinked, dense polyamide discriminating layer on the membrane are described also in U.S. Pat. No. 6,280,853.

The monomers used according to the present invention in order to modify the surface properties of the composite membranes described above are preferably vinyl monomers. The monomers may be either water-soluble, or sparingly soluble in water. By the term “monomer which is sparingly soluble in water” is meant a monomer exhibiting a solubility of less than 0.02 mol/L in water.

The list of water-soluble monomers operative according to the invention include the group of ethylenically-unsaturated compounds and preferably said monomers are selected from the group consisting of acrylic acid, methacrylic acid, acrylonitrile, acrylamide, hydroxyethyl methacrylate, vinylsulfonic acid Na-salt, styrene sulfonic acid, vinyl-pyridine, vinyl-pyrrolidone, vinyl-imidazole, polyethylene glycol containing acrylates, hydroxypropyl methacrylate, dihydroxy propyl-methacrylates, sulfopropylmethacrylate, 2-(dimethylamino)ethylmethacrylate (2-DMAEMA), allylamine, 2-acrylamido-2-methyl-1-propanesulfonic acid, methacryloyloxy-ethyltrimethylammonium chloride, ethylene glycol methacrylate phosphate, ethylene glycol methyl ether methacrylate, styrene, 3-acrylamidopropyltrimethylammonium chloride, methacryloyloxyethyl-trimethylammonium chloride. The water-soluble monomer used according to the invention may be in the form of a salt, which dissociates in water to give a charged polymerizable species which functions as the monomer (such as the quaternary ammonium salts listed above, which, on dissolution in water, release a positively charge monomer). The water-soluble monomer may also be in a zwitterionic form. As an example belonging to the latter sub-class, the acrylic monomer [2-(methacryloyloxy)ethyl]dimethyl-(3-sulfopropyl)ammonium hydroxide may be mentioned. Although the concentration of the water-soluble monomer in the aqueous solution may be up to 1M, a satisfactory degree, of grafting can be reached even if the water-soluble monomer is present in the solution at low concentration, e.g., between 0.01 and 0.1M, and more specifically, from 0.02 to 0.075M. It should be noted that graft copolymerizing of charged monomers, or monomers having zwitterionic form, is generally met with considerable difficulties, since said species may be rejected by some functional groups present on the membrane surface. The method of the invention allows the graft copolymerization of charged and zwitterionic monomers onto the membrane surface even if the concentration of said monomers in the solution is relatively low, e.g., in the range between 0.0001 and 0.02 M.

Sparingly water-soluble monomers useful according to the invention include ethylenically-unsaturated compounds as described above, which are further substituted by one or more hydrophobic groups, having solubility in water of no more than 0.02 M (at room temperature), such as alkylmethacrylate (methylmethacrylate, ethylmethacrylate, propylmethacrylate, isopropylmethacrylate), alkoxyalkyl-substituted methacrylate monomers (methoxyethylmethacrylate, methoxypropyl methacrylate, dimethoxypropyl methacrylate), phenylmethacrylate, polypropylene oxide containing acrylates and glycidyl methacrylate. The monomer is conveniently dissolved is an aqueous solution, free from organic solvents, at a concentration less than 0.02 mol/L, preferably between 0.005 and 0.015 mol/L, and despite the low concentration of the sparingly water-soluble monomer in said solution, the method of the present invention allows a satisfactory degree of graft copolymerization of the monomer onto the surface of the membrane.

It should be noted that multifunctional monomers, namely, compounds substituted with two or more reactive polymerizable groups can also be used according to the invention, either as the monomers to be graft-copolymerize or as additives to aforementioned monofunctional monomers, in order to provide a cross-linked (network) structure of the graft polymer. In this regard, the following compounds, which contain two or more ethylenically unsaturated groups may be mentioned: N,N-methylene bis-acrylamide, divinylbenzene and ethylenglycol dimethacrylate. As indicated above, multifunctional compounds, such as those listed immediately hereinabove, may serve as cross-linking agents in combination with a monofunctional monomer (the later may be either water-soluble or sparingly water-soluble, as identified above). A suitable concentration of a cross-linking agent in the aqueous solution is in the range between 0.001 and 0.1 M.

According to a specific embodiment of the invention, the monomer solution which is contacted with the membrane comprises a water-soluble monomer in combination with a cross-linking agent, which is sparingly soluble in water. It has been observed that the presence of the sparingly water-soluble cross-linking agent in the aqueous solution increases the degree of graft-copolymerization of the water-soluble monomer and shortens the reaction period, namely, the time required to reach a desired degree of graft-copolymerization.

The graft polymerization according to the present invention is preferably carried out in the presence of a free radical initiator, which is generated in the solution and proceeds to react with the membrane surface to form a reactive site thereon. The free radical initiator is most preferably chemically produced. More specifically, the chemical initiation is accomplished using a redox reaction. A redox system operative according to the present invention comprises a water soluble oxidant in combination with a water soluble reductant. A particularly useful combination is that of a persulfate salt as the oxidant, together with a water soluble metabisulfite salt as the reductant, the two together forming a redox pair. Utilizable persulfates include potassium persulfate, sodium persulfate and ammonium persulfate. The metabisulfites include potassium metabisulfite and sodium metabisulfite. Other operative oxidizing agents that may be mentioned are sodium perborate and acetyl peroxide, whereas additional useful reducing agents include ascorbic acid and tetramethylethylenediamine.

The amount of redox pair used is between about 10⁻³ and 10⁻¹ M or between 0.01 and 1 weight percent, based upon the monomer. The redox initiator components are introduced into the reaction vessel in the form of aqueous solutions, whose concentrations vary in the range of 0.01 to 10% (w/w).

In practice, the monomer(s), the initiator(s) and possibly also a cross-linking agent are mixed and dissolved in water to form an aqueous solution with the concentrations noted above, and the resulting solution is placed on one face (the active layer) of the composite membrane mounted in a suitable vessel, following which a transmembrane pressure is generated either by the application of pressure or vacuum. Alternatively, separate solutions may be prepared, each containing one or more of the reactants and reagents indicted above, wherein said solutions are introduced sequentially or simultaneously to the reaction vessel, onto the active layer of the composite membrane positioned therein. The method according to the present invention is carried out in a closed vessel, in which the composite membrane is mountable, which vessel is capable of holding liquids or gases at the intended working pressure. The vessel has at least a feed inlet opening in fluid communication with the face of the membrane to be modified (namely, with the active layer) and at least a permeate outlet opening. One example of a useful vessel is a stainless steel dead end filtration cell that can operate at pressures of 0.1-100 bar. Other suitable vessels are those commonly used in the commercial applications of RO and NF membranes, namely, standard pressure vessels (housing) accommodating a standard commercial filtration element, e.g., of diameter 4″, 8″ or 16″. The modification of the membrane may be carried out in a cross flow cell, having, in addition to the feed inlet opening and the permeate outlet opening, also a concentrate outlet opening. Generally, the concentrate outlet opening is kept closed during the graft copolymerization reaction. However, it is also possible to carry out the process with the concentrate outlet opening being in an open state during at least a portion of the reaction period, or even throughout the reaction period, keeping the feed space pressurized, e.g., by means of an outlet valve. It may be appreciated that in certain circumstances, the graft-polymerization may be even accomplished in-situ, concurrently with a filtration of a solution in the course of a pressure driven membrane application.

Following the introduction of the solution that contains the monomer and the initiator through the feed inlet opening onto the composite membrane within the vessel, pressure is applied. The magnitude of the transmembrane pressure thus produced may be in the range between 0.01 and 100 bars, more preferably between 1 and 80 bars, and even more preferably between 5 and 50 bars. The generation of transmembrane pressure creates a flux across the membrane into the permeate opening, while the graft copolymerization takes place preferentially onto the upper face of the membrane.

In Table 1 below, various types of composite membranes and corresponding commercially available examples are listed, along with operative transmembrane pressures which have been found suitable in allowing an appreciable degree of graft copolymerization onto the membrane surface by the method of the invention:

TABLE 1

| Type of membrane and commercial | |
|---|---|
| examples | Transmembrane pressure |
| Sea water RO membranes, e.g., | Not less than 10 bar |
| FT30 by Dow-Filmtec | Preferably between 20 and 80 bar |
| Brackish water RO membranes, | Not less than 5 bar |
| e.g., BW30 by Dow-Filmtec | Preferably between 10 and 50 |
| Low-pressure RO membranes, e.g., | Not less than 3 bar |
| ESPA1 by Hydranautics-Nitto Denko | Preferably between 5 and 20 |
| Nanofiltration membranes, e.g., | Not less than 1 bar |
| NF200 or NF270 by Dow-Filmtec | Preferably between 5 and 20 |

Thus, the transmembrane pressure applied for the filtration of the aqueous solution which contains the monomers and the initiator during the process is preferably greater than 1 bar, and more preferably greater than 5 bars and even more preferably greater than 10 bars. The modification of the composite membrane is carried out at temperature in the range between 10° C. and 60° C., preferably in the range between 20° C. and 35° C., wherein the graft-copolymerization is generally accomplished to a satisfactory extent following a period of time of 0.5 to 120 min.

In another embodiment of the invention, the surface graft copolymerization is followed by chemical transformation(s) of one or more reactive functional groups present in the graft copolymer. The transformations are accomplished using reagents and conditions well known in the art (see, for example, Organic Chemistry by Morrison and Boyd, Prentice Hall International Edition, sixth edition). A chemical group of particular interest which may be formed in the graft copolymer, following a suitable chemical transformation, is the sulfonate group. For example, pendant epoxy groups present in the grafted polymer may be ring-opened in the presence of a sulfonating agent to give the corresponding sulfonate. Other examples include the direct conversion of the epoxy group to phosphonate, hydroxyl or the attachment of various moieties by means of reaction of the epoxy group with amines. For example, the surface graft polymerization of the monomer glycidyl Methacrylate (GMA) can be followed by ring opening to give a new functional end group via two synthetic pathways:

1. Acid catalyzed cleavage with any kind of nucleophilic reagent.
2. Base catalyzed in alkaline conditions with a nucleophilic reagent.

It should be noted that the process of the invention allows the modification of NF and RO commercially available membranes in two distinct ways. The surface graft copolymerization may result in the formation of film, namely, a new layer with an appreciable thickness on the surface of the membrane, that alters the selectivity of the original active layer (the thickness of such a newly formed film may be in the range between 5 nm and 10 μm). However, it is also possible to alter the characteristics the surface of the membrane (such as, for example, the contact angle of the membrane) without appreciably changing the selectivity of the original top active layer with ‘zero-thickness’, i.e, forming a <5 nm thick, new uniform layer.

The modified composite membrane obtainable according to the invention comprises a porous support, a selective thin polymeric film deposited on said support and a further polymer, which is chemically grafted to the surface of said selective thin film. The grafted polymer comprises a repeating unit (designated B) which may be derived from a sparingly soluble monomer, such as those listed hereinabove, and specifically, from alkyl methacrylate.

In another embodiment, the polymer which is chemically grafted to the surface of the selective thin film of the membrane is cross-linked, said graft polymer comprising a structural unit derived from a multifunctional cross-linking agent, which may be sparingly water-soluble, such as those listed hereinabove.

The presence of a graft polymer on the surface of the membrane (namely, the existence of chemical bonds between functional groups of the selective thin polymeric film of the original membrane, and the polymer consisting of the repeating unit B) has been confirmed by the inventors by removal of all monomers as well as unbound (physically adsorbed) or loosely bound polymers by means of Soxhlet extraction with ethanol, followed by quantitative assessment of the amount of bound graft-polymer using ATR-FTIR spectroscopy of the membrane surface.

Regarding the porous support, it may be suitably made of materials such as polysulfones, cellulose esters, polyether sulfones, polyvinyl chloride, chlorinated polyvinyl chloride, polyvinylidene fluoride, polystyrenes, polycarbonates, polyimides, polyacrylonitriles, and polyesters. Especially preferred is porous support made of polysulfone. Regarding the selective thin polymeric film, which constitutes the active (discriminating) layer of the membrane, it is preferably made of polyamide.

Thus, in another aspect, the present invention provides a nanofiltration composite membrane, or a reverse osmosis composite membrane, comprising:

(i) a porous support;
(ii) a selective thin polymeric film deposited on said support; and
(iii) a further polymer, which is chemically grafted to the surface of said selective thin film,
characterized in that said graft polymer comprises a repeating unit derived from a sparingly water-soluble monomer (such as those identified above).

Preferably, the graft polymer is poly (ethylmethacrylate) or poly(glycidyl methacrylate), and the corresponding sulfonate-containing derivative of the latter, obtainable by the transformation of the glycidyl moiety into sulfonate.

In another embodiment, the present invention provides a nanofiltration composite membrane, or a reverse osmosis composite membrane, comprising:

(i) a porous support;
(ii) a selective thin polymeric film deposited on said support; and
(iii) a further polymer, which is chemically grafted to the surface of said selective thin film,
characterized in that the graft polymer is cross-linked, said graft copolymer comprising a structural unit derived from a multifunctional cross-linking agent, which is sparingly water-soluble (such as those listed above).

The degree of graft polymerization on the surface of the membrane, as achieved by the present method, can be conveniently quantified using Fourier Transform infrared (FTIR) spectroscopy. To this end, the intensities of first and second characteristic peaks, assigned to functional groups of the graft copolymer and the unmodified, original membrane, respectively, are measured and the ratio between said first and second peaks is calculated. The greater the ratio between the intensities of the first and second peaks, the greater is the degree of graft copolymerization reached by the process. A desired degree of graft copolymerization is attainable by the present method using relatively low concentrations of monomer(s) and cross-linking agents, as compared with a corresponding process carried out without the generation of transmembrane pressure. Generally, it has been observed that the application of pressure in accordance with the present method allows the concentration of the monomer(s) to be reduced by about one order of magnitude.

It has been observed that the graft degree, derived from measurements made at different points on the surface of the modified membrane by the technique set for the above, exhibits considerable variance. The relatively large standard deviation associated with the ATR-FTIR measurements used to determine the graft degree is indicative of the formation of a non-uniform graft-polymer layer on the surface of the membrane. Without wishing to be bound by theory, it is believed that under the conditions of the process of the invention, the top graft-polymer layer preferentially forms over more permeable and less selective or defect areas of the original dense membrane and thus changes the selectivity in the most efficient way. This feature does not exist when no trans-membrane pressure difference is used and is supported by analysis of the relation between the amount of grafted polymer (by ATR-FTIR) and the change in flux and selectivity. Thus the most dramatic change in permeability and rejection was observed already at very low grafting (as quantitatively determined by ATR-FTIR) upon sealing the less selective or damaged areas, whereas subsequent grafting added a marginal improvement in these characteristics.

In another embodiment, the present invention provides a nanofiltration composite membrane, or a reverse osmosis composite membrane, comprising:

(i) a porous support;
(ii) a selective thin polymeric film deposited on said support; and
(iii) a further polymer, which is chemically grafted to the surface of said selective thin film,
characterized in that the average graft degree of said further polymer on said surface, as determined by attenuated total reflection Fourier transform infrared (ATR-FTIR) spectroscopy and expressed by the average ratio between the intensities of first and second characteristic peaks, assigned to functional groups of said grafted polymer and porous support, respectively, is associated with a standard deviation of not less than 25%, e.g., in the range between 25 and 50%, wherein the individual ratios used to calculate said average graft degree were derived from measurements made at different points on the surface.

The modified composite membrane may be used in membrane filtration processes in various water treatment applications, such as those applied for the removal of inorganic constituents and in particular in desalting brackish water and seawater and for the removal of organic chemicals, as well as for reducing propensity to organics, inorganic and biological fouling or their combination. In particular, the present invention provides a process for treating water, which process comprises feeding a water stream into a membrane separation unit having a composite membrane as described above mounted therein, passing said water stream under pressure across said composite membrane to produce a low solute containing permeate stream and a high solute containing concentrate stream, wherein said solute comprises a salt, a boron compound or an organic contaminant, or a mixture thereof. In the case of boron rejection, the passage of boron through said composite membrane is preferably less than 35% (calculated as boric acid) and even more preferably less than 30%, relative to the amount of boron in the feedwater stream. In the case of the rejection of organic contaminants, the passage of said contaminant through said composite membrane is preferably less than 20%, and even more preferably less than 10%, relative to the amount in the feedwater stream.

### EXAMPLES

The graft degree (GD) was determined by attenuated total reflection Fourier transform infrared (FTIR-ATR) spectroscopy. ATR-FTIR spectra (average of 64 scans at 4 cm⁻¹ resolution) were recorded on a Vertex 70 FTIR spectrometer (Bruker) using a Miracle ATR attachment with a one-reflection diamond-coated KRS-5 element (Pike). The GD was measured from

$$G D = \frac{{I}_{mon}}{{I}_{mem}}$$

where Iₘₘ is the intensity of the 1724-1728 cm⁻¹ band assigned to carbonyl group and characteristic of acrylic monomers and polymers and Iₘₑₘ is a band of polysulfone (part of the original membrane) at 1586 or 1488 cm⁻¹, which usually changes insignificantly upon modification unless the grafted layer is commensurable or thicker than the penetration depth of evanescent IR wave (−1 μm). The GD is measured on several (e.g., seven) different points at various regions of a given membrane, such that the points are uniformly distributed over the sample, followed by calculating the mean GD and the standard deviation associated with the GD of said membrane.

X-ray photoelectron spectroscopy (XPS) spectra were measured using ESCALAB 250 spectrometer with A1 X-ray source and monochromator. General survey and high-resolution spectra of elements were recorded. Calibration of peak position was performed according to the position of the C1s line (285 eV). For XPS analysis the powder samples were mounted on Indium foil and analysis were performed at basic pressure of 3×10⁻⁹ mbar. In order to avoid surface contamination influence the Ar-etching was done under the pressure of 1×10⁻⁸ mbar using the ion source with 1 mA 1 kV power.

### Example 1

### Graft Copolymerization of a Water Soluble Monomer onto the Surface of RO Membrane in the Presence of Redox Initiator Under Pressure

A low pressure fully aromatic reverse osmosis membrane ESPA1 of diameter 30 mm was mounted in a stainless steel dead end filtration cell that could be pressurized to a working pressure using nitrogen from a gas cylinder. Prior to the modification according to the invention the RO membrane was tested for the initial flux and initial salt rejection using a 1.5 g/L NaCl solution at an operating pressure of 20 Bar.

The initiator and monomers solutions are prepared as follows. A 50 ml Erlenmeyer equipped with a magnetic bar was filled with 25 ml of DDW water and 0.0889 mg potassium metabisulfite, and the mixture was stirred to form a solution. A 50 ml Erlenmeyer equipped with a magnetic bar was filled with 50 ml of DDW water and 0.113 g potassium persulfate, and the mixture was stirred to form a solution. A 100 ml Erlenmeyer equipped with a magnetic bar was filled with 50 ml of DDW water and 212 μl HEMA and the mixture was stirred to form a solution.

The three solutions were then mixed together for 10 sec and 50 ml of the combined solution (4 mM potassium metabisulfite, 4 mM potassium per sulfate and 0.035 M HEMA) were inserted into the stainless steel dead end filtration cell. The solution was pressurized to 20 bar and filtered for 30 minutes.

Thereafter the membrane was taken out and washed for 24 hours in a 50/50 v/v solution of water/ethanol to remove monomers and non-grafted polymer. The modified membrane was mounted in a filtration cell and tested again for water permeability and salt rejection. The tested membrane was then taken out, dried in a vacuum oven in 40° C. for at least 2 hours and the degree of modification was quantified using attenuated total reflection FTIR spectroscopy. The degree of modification was calculated from the ratio between the intensities of the 1724 cm⁻¹ band (characteristic of the grafted polymer) and the 1586 cm⁻¹ band (characteristic of the polysulfone support of the membrane).

The flux reduction as a result of the modification was 22%. No change in salt rejection was observed. The intensity ratio of IR bands at 1724 and 1586 cm⁻¹ was 0.326.

### Example 2

### Comparative

The procedure of Example 1 was repeated, but this time the solution was not pressurized and filtered. The resulting membrane was then tested as described in Example 1. The flux reduction was negligible. No change in salt rejection was observed.

The intensity ratio of IR bands at 1724 and 1586 cm⁻¹ was 0.02, indicating a very poor degree of graft copolymerization onto the surface of the membrane.

### Example 3

### The Effect of the Concentration of the Water Soluble Monomer in the Solution on the Degree of Graft Copolymerization

The procedure of Example 1 was repeated except that the HEMA concentration was varied according to the data given Table 2 below. Consistent increase in the degree of modification with monomer concentration and flux (Jv) reduction were observed, indicating the formation of an increasingly thick layer of poly-HEMA on top of the RO membrane. No change in salt rejection was observed.

TABLE 2

| HEMA | Jv | 1724/1586 | Standard |
|---|---|---|---|
| concentration (M) | decrease (%) | cm⁻¹ | deviation |
| 0.02 | 24 | 0.147 | 0.043 |
| 0.035 | 26 | 0.326 | 0.108 |
| 0.05 | 30 | 0.727 | 0.437 |
| 0.075 | 25 | 1.373 | 0.669 |

### Example 4

### Graft Copolymerization of Sparingly Soluble Monomer onto the Surface of RO Membrane in the Presence of Redox Initiator Under Pressure

The procedure of example 1 was repeated except that the low-soluble monomer ethylmethacrylate (EMA) was used at concentration 0.008 M. The resulting membrane was tested, showing that salt rejection increased from 94% to 98%, the flux reduced by 26% and the ratio of IR bands at 1724 and 1586 cm⁻¹ was 4.5, indicating formation of a dense extra layer of poly-EMA on top of the membrane.

### Example 5

### Graft Copolymerization of Water Soluble Monomer onto the Surface of RO Membrane in the Presence of Redox Initiator Under Pressure

A low pressure fully aromatic reverse osmosis membrane LE (Dow) of 17 mm length and 2 mm width was mounted in a stainless steel cross flow cell. The cross flow cell was connected at the inlet side to a stainless steel cell, where the solution is inserted and could be pressurized to a working pressure using nitrogen from a gas cylinder. The concentrate side was sealed. The membrane was tested prior to the modification as described in example 1.

The modification procedure was as described in example 1 expect that the monomer was 0.01 M polyethylene glycol methacrylate. The intensity ratio of the IR bands at 1728 and 1586 cm⁻¹ was 0.1.

### Example 6

### Graft Copolymerization of Sparingly Water Soluble Monomer onto the Surface of RO Membrane in the Presence of Redox Initiator Under Pressure

The procedure of example 1 was repeated, except that the monomer used was the sparingly water soluble glycidyl methacrylate (GMA), at a concentration of 0.002 M. The intensity ratio of IR bands at 1730 and 1586 cm⁻¹ was 0.4, indicating that a new layer was grafted on the membrane surface, as was confirmed by a flux decrease of 40%. The salt rejection improved from 96 to 98% due to the new modification layer.

### Example 7

### The Effect of the Presence of a Sparingly Soluble Cross-Linking Agent on the Degree of Grafting of a Water Soluble Monomer onto the Membrane

The procedure of example 1 was repeated, but this time the sparingly soluble cross-linking agent ethyleneglycol dimethacrylate was added to the solution at concentration of 0.12 mM (0.2% w/w from monomer).

As shown in Table 3, the presence of the cross-linking agent in the solution increases the degree of grafting of the HEMA monomer onto the surface of the membrane (when compared with an identical HEMA concentration, but with no cross linker in the solution; the results reported in Table 3 are for 0.035 M HEMA concentration in the aqueous solution). The results also show that the time required to reach a specific degree of grafting can be significantly shortened by adding the sparingly soluble cross-linking agent to the monomer solution.

TABLE 3

| | 1724/1586 cm⁻¹ | 1724/1586 cm⁻¹ |
|---|---|---|
| Time (Min) | With EGDMA | Without EGDMA |
| 7.5 | 0.087 | 0.030 |
| 15 | 0.442 | 0.129 |
| 22.5 | 1.193 | 0.235 |
| 30 | 2.530 | 0.321 |

### Example 8

### The Effect of the Concentration of the Redox Initiator in the Solution on the Degree of Graft Copolymerization of a Water Soluble Monomer onto the Surface of the Membrane

The procedure of example 1 was repeated, testing various concentrations of the persulfate/metabisulfite redox pair in the solution.

The degrees of modification determined for the tested concentrations (as indicated by the ratio of IR bands at 1724 and 1586 cm⁻¹) are presented in Table 4. Effective degree of modification is attainable at a concentration of 0.002-0.004 M of K₂S₂O₅ and 0.0004-0.004 M of K₂S₂O₈.

TABLE 4

K₂S₂O₈

| K₂S₂O₅ | 0.0004 | 0.001 | 0.002 | 0.004 |
|---|---|---|---|---|
| 0.001 | — | 0 | 0 | 0 |
| 0.002 | — | — | — | 1.050 |
| 0.004 | 0.186 | 0.216 | 0.269 | 0.369 |

### Example 9

### Graft Copolymerization of a Sparingly Water Soluble Monomer onto the Surface of RO Membrane in the Presence of Redox Initiator Under Pressure, Followed by a Chemical Modification of the Resulting New Layer

The procedure of example 1 was repeated, except that the monomer glycidyl methacrylate (GMA) was used at a concentration ranging in the range between 0.002 and 0.004 M. The resulting membrane was tested, showing that salt rejection increased from 96% to 98%, the flux reduced by 15-45% and the ratio 1730/1586 was in the range between 0.2 and 1, indicating formation of an extra layer of poly-GMA on top of the membrane with a different thickness depending on the GMA concentration. The passage of boric acid (5 ppm, pH 7.5) across the membrane was measured.

The modified membrane was then subjected to a chemical reaction, converting the epoxy group of the poly-GMA into a new group, as follows:

a. Sulfonic functionalized end group (by placing the membrane in a solution of Na₂SO₃ at pH 1.5, at 40° C., for 24 hours).

b. 2,3-dihydroxypropyl methacrylate (by placing the membrane in a solution of 0.25 M H₂SO₄, at 40° C., for 24 hours).

c. 2-aminoethyl phosphate (by contacting the membrane with NH₂(CH₂)₂PO₄H₂, at 25°, for 24 hours).

As a result of the chemical transformations set forth above, the membrane exhibited the following surface characteristics, respectively:

a. The IR spectrum of the membrane indicates a new IR band at 1040 cm⁻¹, attributed to a sulfate, and the disappearance of the characteristic epoxy band at 908 cm¹. The contact angle decreased from 35° to 20°.

b. The IR spectrum of the membrane indicates a new IR band at 1040-1060 cm⁻¹, attributed to the hydroxyl, and the disappearance of the epoxy band at 908 cm⁻¹. The contact angle decreased from 35° to 20°.

c. A decrease of about 20% in the flux across the membrane is observed following the chemical modification (in comparison with the GMA modified membrane), indicating that the modified GMA layer has underwent a chemical change. The conversion of the epoxy group into 2-aminoethyl phosphate brought an improvement in the salt rejection (from 98% to 99%). A decrease in the passage of the boric acid, from 40% to 22% is also observed.

### Example 10

### Graft Copolymerization of a Charged Water Soluble Monomer onto the Surface of RO Membrane in the Presence of Redox Initiator Under Pressure

The procedure of example 1 was repeated, except that this time a positively charged monomer [2(Methacryloyloxy)ethyl]trimethylammonium (in the form of the chloride salt) was used, at a concentration of 0.01 M, and the concentration of K₂S₂O₅ was 0.002 M. The intensity ratio of IR bands at 1724 and 1586 cm⁻¹ was 0.1 and a new band at 945 cm⁻¹ attributed to the quaternary amine appeared in the IR spectrum. The contact angle decreased to 25°. XPS analysis showed a new quaternary amine band at 402 eV.

### Example 11

### Graft Copolymerization of a Zwitterion Soluble Monomer onto the Surface of RO Membrane in the Presence of Redox Initiator Under Pressure for Improving Anti-Biofouling Surface Characteristics

The procedure of example 1 was repeated, except that the monomer used was [2-(Methacryloyloxy)ethyl]dimethyl-(3-sulfopropyl)ammonium hydroxide, at a concentration of 0.05 M.

The intensity ratio of the IR bands at 1724 and 1586 cm⁻¹ was 0.1 and a new band at 1040 cm⁻¹ attributed to the sulfone appeared in the IR spectrum. The contact angle decreased to 33°. XPS analysis showed a new quaternary amine band at 402 eV.

The flux across the membrane decreased by 15% following the graft copolymerization, indicating a surface modification that enables to improve the membrane antifouling properties. Indeed, bacterial initial deposition (pseudomonas florescent) that was tested using a cross flow cell showed an order of magnitude less adhesion after 30 minutes in respect of the unmodified ESPA-1 membrane.

### Example 12

### Improved Boron Rejection Using Graft Copolymerization of Sparingly Soluble Monomer onto the Surface of RO Membrane in the Presence of a Cross-Linker and Redox Initiator Under Pressure

The procedure of example 4 was repeated except that the monomer solution contained 0.0075 M EMA and 0.1% (w/w) cross linker ethyleneglycol dimethacrylate (EGDMA). The resulting membrane was tested, showing increase in salt rejection from 96.6% to 98.8%, flux reduction by 63.5% and the ratio 1727/1586 cm⁻¹ was 10.

The membrane also showed reduced passage of boron as boric acid, which dropped from 36% to 27%, as was examined by filtering 10 ppm boric acid solution at pH 7 and an operating pressure of 20 bars.

### Example 13

### Improved Rejection of Organic Contaminant Using Graft Copolymerization of Water Soluble Monomer onto the Surface of NF Membrane in the Presence of Redox Initiator Under Pressure

The procedure of Example 1 was repeated using a semiaromatic nanofiltration membrane NF-200 (Dow-Filtec) and a 0.1 M solution of a hydrophilic monomer HEMA.

The resulting modified membrane was tested, showing that the flux at 20 bar decreased after modification from 186 to 136 L/m²/h and Na₂SO₄ rejection (500 ppm in the feed) increased from 83 to 94%. Passage of a hydrophobic herbicide Metolachor (10 ppm in the feed in presence of 500 ppm Na₂SO₄) dropped from 48% for original, non-modified membrane to 8.5% after modification.

1) A method for modifying the surface of nanofiltration (NF) and reverse osmosis (RO) composite membranes, comprising placing said composite membrane in a suitable vessel having a feed inlet opening and a permeate outlet opening, feeding an aqueous solution of one or more monomer (s) and free radical initiator into said vessel through said inlet opening, generating transmembrane pressure, thereby creating a flux across said membrane into said permeate outlet opening and causing said monomer (s) to graft polymerize in the presence of said free radical initiator onto one face of said composite membrane.

2) A method according to claim 1, wherein the free radical initiator is a redox initiator comprising a water soluble oxidant in combination with a water soluble reductant.

3) A method according to claim 2, wherein the transmembrane pressure generated for creating the flux of the aqueous solution is not less than 1 bar (100 kPa).

4) A method according to claim 3, wherein transmembrane pressure is not less than 10 bars (1000 kPa).

5) A method according to claim 3, wherein the monomer is a water-soluble monomer, and the solution further comprises one or more cross-linking agents.

6) A method according to claim 3, wherein the monomer is sparingly soluble in water, said monomer having solubility in water of no more than 0.02 M at room temperature.

7) A process according to claim 1, which further comprises the chemical transformation of a pendant functional group present in the graft polymer.

8) A process according to claim 7, wherein the pendent functional group is epoxy group which is chemically transformed into a sulfonate group.

9) A composite membrane, suitable for use as nanofiltration or reverse osmosis membrane, comprising:
(i) a porous support;
(ii) a selective thin polymeric film deposited on said support; and
(iii) a further polymer, which is chemically grafted to the surface of said selective thin film, characterized in that said graft polymer comprises a repeating unit derived from a sparingly water-soluble monomer.

10) Composite membrane according to claim 9, wherein the sparingly soluble monomer is selected from the group consisting of alkylmethacrylate, alkoxyalkyl-substituted methacrylate, phenylmethacrylate, polypropylene oxide containing acrylates and glycidyl methacrylate.

11) A composite membrane, suitable for use as nanofiltration or reverse osmosis membrane, comprising:
(i) a porous support;
(ii) a selective thin polymeric film deposited on said support; and
(iii) a further polymer, which is chemically grafted to the surface of said selective thin film, characterized in that the graft polymer is cross-linked, said graft polymer comprising a structural unit derived from a multifunctional cross-linking agent, which is sparingly water-soluble.

12) A composite membrane according to claim 11, wherein the sparingly water soluble multifunctional cross-linking agent is selected from the group consisting of ethyleneglycol dimethacrylate, N,N-methylene bis-acrylamide and divinylbenzene.

13) A nanofiltration composite membrane or a reverse osmosis composite membrane, comprising:
(i) a porous support;
(ii) a selective thin polymeric film deposited on said support; and
(iii) a further polymer, which is chemically grafted to the surface of said selective thin film, characterized in that the average graft degree of said further polymer on said surface, as determined by attenuated total reflection Fourier transform infrared (ATR-FTIR) spectroscopy and expressed by the average ratio between the intensities of first and second characteristic peaks, assigned to functional groups of said grafted polymer and porous support, respectively, is associated with a standard deviation of not less than 25%, wherein the individual ratios used to calculate said average graft degree were derived from measurements made at different points on the surface of the membrane.

14) A composite membrane according to claim 9, wherein the porous support and the thin polymeric film comprise polysulfone and polyamide, respectively.

15) A process for treating water, which process comprises:
(a) feeding a water stream into a membrane separation unit having a composite membrane according to claim 1, or
(b) passing said water stream under pressure across said composite membrane to produce a low solute containing permeate stream and a high solute containing concentrate stream, wherein said solute comprises a salt, a boron compound or an organic contaminant, or a mixture thereof.

16) A composite membrane according to claim 11, wherein the porous support and the thin polymeric film comprise polysulfone and polyamide, respectively.

17) A composite membrane according to claim 13, wherein the porous support and the thin polymeric film comprise polysulfone and polyamide, respectively.

18) A process for treating water, which process comprises:
(a) feeding a water stream into a membrane separation unit having a composite membrane according to claim 1, or a composite membrane, suitable for use as nanofiltration or reverse osmosis membrane, comprising:
(i) a porous support;
(ii) a selective thin polymeric film deposited on said support; and
(iii) a further polymer, which is chemically grafted to the surface of said selective thin film, characterized in that said graft polymer comprises a repeating unit derived from a sparingly water-soluble monomer,
(b) passing said water stream under pressure across said composite membrane to produce a low solute containing permeate stream and a high solute containing concentrate stream, wherein said solute comprises a salt, a boron compound or an organic contaminant, or a mixture thereof.

19) A process for treating water, which process comprises:
(a) feeding a water stream into a membrane separation unit having a composite membrane according to claim 1, or a composite membrane, suitable for use as nanofiltration or reverse osmosis membrane, comprising:
(i) a porous support;
(ii) a selective thin polymeric film deposited on said support; and
(iii) a further polymer, which is chemically grafted to the surface of said selective thin film, characterized in that the graft polymer is cross-linked, said graft polymer comprising a structural unit derived from a multifunctional cross-linking agent, which is sparingly water-soluble,
(b) passing said water stream under pressure across said composite membrane to produce a low solute containing permeate stream and a high solute containing concentrate stream, wherein said solute comprises a salt, a boron compound or an organic contaminant, or a mixture thereof.

20) A process for treating water, which process comprises:
(a) feeding a water stream into a membrane separation unit having a composite membrane according to claim 1, or a nanofiltration composite membrane or a reverse osmosis composite membrane, comprising:
(i) a porous support;
(ii) a selective thin polymeric film deposited on said support; and
(iii) a further polymer, which is chemically grafted to the surface of said selective thin film, characterized in that the average graft degree of said further polymer on said surface, as determined by attenuated total reflection Fourier transform infrared (ATR-FTIR) spectroscopy and expressed by the average ratio between the intensities of first and second characteristic peaks, assigned to functional groups of said grafted polymer and porous support, respectively, is associated with a standard deviation of not less than 25%, wherein the individual ratios used to calculate said average graft degree were derived from measurements made at different points on the surface of the membrane,
(b) passing said water stream under pressure across said composite membrane to produce a low solute containing permeate stream and a high solute containing concentrate stream, wherein said solute comprises a salt, a boron compound or an organic contaminant, or a mixture thereof.
